(19) United States
(12) Patent Application Publication
(10) Pub. No.: US 2024/0214965 A1
(43) Pub. Date: Jun. 27, 2024

(54) ATTACHMENT OF A USER EQUIPMENT TO A MOBILE PRIVATE NETWORK

(71) Applicant: VODAFONE GROUP SERVICES LIMITED, Newbury, Berkshire (GB)

(72) Inventors: Yalou WANG, London (GB); Alan Richard HARPER, London (GB); Assen Mahaboob Khan GOLAUP, London (GB)

(21) Appl. No.: 18/557,228

(22) PCT Filed: Apr. 26, 2022
(86) PCT No.: PCT/GB2022/051045

§ 371 Date: Oct. 25, 2023

(30) Foreign Application Priority Data
Apr. 26, 2021 (GB) 2105929.0

(51) Int. Cl. H04W 60/06; H04W 8/02; H04W 36/08

(52) U.S. Cl. CPC H04W 60/06; H04W 8/02; H04W 36/08

(57) ABSTRACT

Reattachment of a User Equipment (UE) from a Public Land Mobile Network (PLMN), on which the UE is roaming, to a Mobile Private Network (MPN) can be instigated by: identifying at the PLMN that the UE is associated with the MPN; and initiating, at a core network of the PLMN or the MPN, a detach of the UE from the PLMN in response to the identification.

### TECHNICAL FIELD OF THE DISCLOSURE

The disclosure relates to instigating a reattachment of a User Equipment (UE) from a Public Land Mobile Network (PLMN), on which the UE is roaming, to a Mobile Private Network (MPN) and a suitably configured network entity of a PLMN.

### BACKGROUND TO THE DISCLOSURE

A Mobile Private Network (MPN, sometimes termed a Private Mobile Network) comprises a cellular network infrastructure configured for exclusive use by specific authorised subscribers and/or devices. The MPN geographical coverage is typically limited to a small area (for example, a factory or campus) and intended for devices used by a specific organisation located in the coverage area. Devices for use on the MPN generally have a Subscriber Identity Module (SIM) dedicated to the MPN. Subscribers registered on a Public Land Mobile Network (PLMN) can only access the MPN if they are authorised.

The coverage area of the MPN generally overlaps with the coverage area of at least one PLMN and often more than one PLMN. A User Equipment (UE) having a SIM registered with the MPN is allowed to roam out from the MPN and use an external PLMN, for example when the UE is located outside the coverage area of the MPN. When the UE comes back to the MPN coverage area however, it may be stuck on the PLMN, due to the coverage of the PLMN overlapping with that of the MPN.

A known approach for dealing with this situation is to wait until the UE is in Idle Mode Cell Reselection. The UE will then reattach to MPN cells using high priority cell frequency bands. This only works for MPN cells operating in dedicated frequency bands (a dedicated Radio Access Network, RAN).

Cells of the MPN can operate on the same frequencies as cells of the PLMN. This further complicates reattachment of the UE to the MPN, as Idle Mode Cell Reselection will not work. The only known option in such cases is to force the UE to power cycle. Even this may not reattach the UE to the MPN, as the UE may try the stored network identities, for example the Mobility Management Entity (MME), of the PLMN. It is understood that a Dedicated Core Network (DECOR) redirection will be able to control reattachment of the UE in such circumstances, but even this may not always work. For example, if the UE is stuck in connected mode or is not accessible to initiate a power cycle, this approach may not reattach the UE to the MPN.

A more robust technique for reattaching the UE to the MPN when it is within the coverage area of the MPN, but attached to the PLMN is therefore desirable.

### SUMMARY OF THE DISCLOSURE

Against this background, the present disclosure provides a method of instigating a reattachment of a User Equipment (UE) from a Public Land Mobile Network (PLMN), on which the UE is roaming, to a Mobile Private Network (MPN) according to claim 1 and a network entity of a PLMN in line with claim 12. Other preferred features are disclosed with reference to the claims and in the description below.

Detaching the MPN UE from the PLMN can be initiated at a core network of the PLMN or MPN. Thus, the PLMN may identify the UE as being associated with, authorised on or dedicated for the MPN and initiate the detach accordingly. The PLMN (for example, the core network of the PLMN) may also first identify that the UE is within Radio Access Network (RAN) coverage of the MPN before initiating the detach. The detach may be performed at (more specifically, by) a network entity, for example one or more of: a Mobility Management Entity (MME) of the PLMN; a central Packet Data Network Gateway (PGW) of the MPN; and a Home Subscriber Server (HSS) of the MPN. The approach of the disclosure may be embodied as a method and/or as a network entity configured to implement the approach.

In some scenarios, the PLMN cell to which the UE is attached may have the same PLMN identifier as a cell of the MPN having an overlapping coverage area. Even so, the MPN cell and PLMN cell may each have a different Tracking Area Code (TAC). In certain scenarios, the PLMN cell to which the UE is attached may use the same frequency as a cell of the MPN (having an overlapping coverage area).

Determining, at the core network of the PLMN (for example at the MME), that the UE has triggered a Tracking Area Update (TAU) and/or an intra-frequency handover can be used to initiate the process. This may allow the PLMN to determine that the UE has entered a coverage area or Tracking Area with overlapping MPN coverage. The UE can then be identified as associated with the MPN. Where the MPN and PLMN cells use the same frequencies, the MME can initiate the detach based on the TAU or handover triggering.

A different approach may be used where the MPN and PLMN cells use different frequencies. For instance, the PLMN may first determine that a cell (or more than one cells) of the MPN appears on a UE inter-frequency measurement. An inter-frequency handover threshold for the UE may then be adjusted (at the PLMN cell to which the UE is attached). This adjustment may then cause the UE to attempt an inter-frequency handover. Such a handover attempt will fail. However, the attempt may be detected at the MME of the PLMN, which may then initiate the detach of the UE in response.

In another approach, a location report may be communicated from the UE to the PLMN (this may comprise transmitting the location report from the UE to the PLMN and/or receiving the location report from the UE at the PLMN). The location report advantageously indicates that the UE is in a coverage area of the MPN, which may allow the identification of the UE to be performed. The UE may determine its location (for example using a Global Navigation Satellite System technology) and communicate the location report accordingly. The location report may indicate the determined location, for example. Additionally or alternatively, the location report may instruct the PLMN to initiate the detach of the UE.

Any of the methods disclosed herein may be performed by a computer program. A computer program comprising instructions which, when the program is executed by a processor, cause the processor to carry out any method disclosed herein may also be provided. Combinations of aspects or features between aspects may also be provided.

### BRIEF DESCRIPTION OF THE DRAWINGS

The approach of the disclosure may be put into practice in various ways, one of which will now be described by way of example only and with reference to the accompanying drawings in which:

FIG. 1 shows a schematic diagram of a network architecture where cells of a PLMN share the same frequency as cells of a MPN;

FIG. 2 illustrates a schematic diagram of a network architecture where cells of a PLMN use a different frequency from cells of a MPN; and

FIG. 3 depicts a flow chart of a procedure according to the disclosure.

Where a drawing indicates a feature also shown in another drawing, identical reference numerals have been used.

### DETAILED DESCRIPTION OF PREFERRED EMBODIMENTS

The general approach according to the present disclosure is for the core network to initiate detach of the UE. This approach is robust and effective. A number of possible implementations can be considered, some of which depend on whether the one or more PLMN cells having overlapping coverage with one or more MPN cells share the same frequency or use different frequencies.

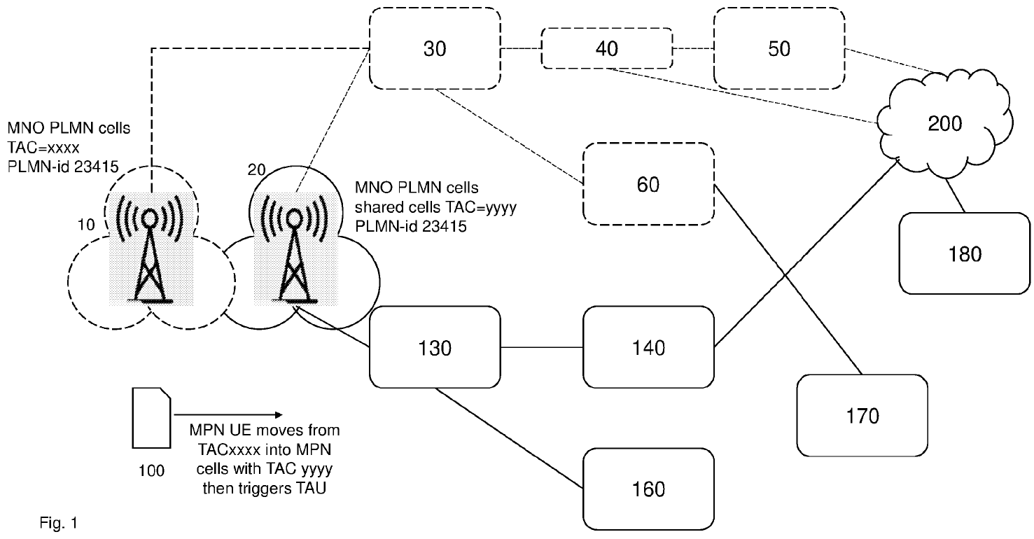

Referring first to FIG. 1, there is shown a schematic diagram of a network architecture where cells of a PLMN share the same frequency as cells of a MPN. The network architecture comprises: a first Tracking Area 10; a second Tracking Area 20; a PLMN MME 30; a PLMN Diameter Routing Agent (DRA) 40; a PLMN Home Subscriber Server (HSS) 50; a PLMN Serving Gateway (SGW) 60; a MPN MME 130; a MPN DRA 140; a MPN Serving/Packet Data Network Gateway (S/PGW) 160; an IoT Central PGW 170; an IoT Central Common Subscriber Database (CSDB) 180; and a Diameter Roaming Service (DRS) 200. Also shown is a MPN IoT SIM 100, which is associated with a UE (not shown). The PLMN may be managed by a mobile network operator (MNO). The MPN is managed separately from the PLMN. The DRS 200 is a Diameter signalling network, connecting core network components of the PLMN and the MPN together, especially each HSS from different operators (for instance HSS 50 and IoT CSDB 180).

The first Tracking Area 10 has only PLMN cells and a first Tracking Area Code (TAC), xxxx. The second Tracking Area 20 has both at least one PLMN cell and at least one MPN cell and a second TAC, yyyy. The second TAC identifies that the second Tracking Area 20 has both PLMN and MPN cells and is therefore different from the first TAC (or any other TAC for a Tracking Area with only PLMN cells). This is especially relevant where the PLMN and MPN cells use the same frequency. However, the PLMN-id (PLMN identifier) for each of the PLMN and the MPN is the same (23415).

When the UE having the MPN IoT SIM 100 enters the second Tracking Area 20, it triggers a Tracking Area Update (TAU). This may not happen immediately on entering the second Tracking Area 20, but if not, a periodic TAU will take place (for example every one to two hours). The TAU is detected at the PLMN MME 30 and/or the PLMN SGW 60 and the IoT CSDB 180 may be informed (in accordance with section 5.3.3 of 3GPP TS 23.401). Any one of these network entities may therefore initiate a UE detach (which will be followed by re-attach of the UE to MPN), after TAU is complete.

An alternative to using TAU to trigger a detach procedure may be to use a handover procedure. When the UE having the MPN IoT SIM 100 enters the second Tracking Area 20, the normal handover (X2-based or S1-based) procedure may be triggered (see 3GPP TS 36.300 section 10.1.2.1.1 for call flow). This procedure normally operates using the PLMN MME 30 (intra-MME) and the PLMN SGW 60 (intra-SGW), but it may operate between the PLMN MME 30 and the MPN MME 130 (inter-MME) and/or between the PLMN SGW 60 and the MPN S/PGW 160 (inter-SGW). This does not matter, as the trigger procedure would remain the same in the target MME. The minimum trigger could be a S1-AP Path Switch command. Other triggers can be considered if appropriate. When the MME receives the Path Switch request and obtains the relevant eNB identifier, it can identify the MPN cell/eNB and triggers a MME-initiated detach with re-attach required. The MME may beneficially store a global eNB identifier database used for MPN sharing (similar to TAC used for MPN selection). An advantage of this approach is that the detach can be instant (after a small guard timer) so this may allow quick switching to MPN. The small guard timer may provide hysteresis, to prevent handover “Ping-Pong”, which is a situation in which a UE may perform handover between the same cells more frequently than actually required, for example because propagation conditions between the UE and the cells are similar.

A number of options for implementing the UE detach may be considered. In a first option, the PLMN MME 30 may initiate the UE detach and reattach, in accordance with 3GPP TS 23.401, section 5.3.8.3. This may involve the PLMN MME 30 implementing a trigger that is not currently implemented. A second option comprises the IoT Central PGW 170 initiating an Evolved Packet System (EPS) bearer deactivation that will cause detach, in accordance with 3GPP TS 23.401, section 5.4.4.1. As the UE will typically use the IoT Central PGW 170 for services outside the MPN, this approach may be advantageous. Indeed, this approach can allow the network to wait until no data transmission is being made (even in connected mode) to trigger detach. A third option would be for the IoT Central CSDB 180 to initiate a UE detach and reattach. This is in accordance with 3GPP TS 23.401, section 5.3.8.4. This may be beneficial from the point of view of provisioning. Even if the UE continues to connect to the PLMN MME 30 following a re-attach (due to stored identifiers at the UE), the Dedicated Core Network (DECOR) redirection should resolve this problem.

In a general sense, there may be considered a method of instigating a reattachment of a User Equipment (UE) from a Public Land Mobile Network (PLMN), on which the UE is roaming, to a Mobile Private Network (MPN). The method comprises: identifying at the PLMN that the UE is associated with the MPN; and initiating, at a core network of the PLMN or the MPN, a detach of the UE from the PLMN in response to the identification. There may also be considered a network entity of a PLMN that is configured to allow a UE associated with a MPN to roam on the PLMN. The network entity may be configured to operate in accordance with any method as herein disclosed.

Advantageously, identifying that the UE is associated with the MPN may also include identifying (at the PLMN) that the UE is within Radio Access Network (RAN) coverage of the MPN. For example, this may be achieved using Tracking Area Codes (TAC). In some embodiments, the UE may be attached to a cell of the PLMN, the cell of the PLMN and a cell of the MPN having overlapping coverage areas. Then, the cell of the PLMN and the cell of the MPN may have different TACs and/or the same PLMN identifier.

In some embodiments, a cell of the PLMN to which the UE is attached uses the same frequency as a cell of the MPN.

The core network of the PLMN may determine that the UE has triggered a Tracking Area Update (TAU) or an intra-frequency handover. For example, the core network of the PLMN may further establish that a new Tracking Area comprises both PLMN and MPN cells. Additionally or alternatively, the core network of the PLMN may further establish that the UE is in the coverage area of at least one cell of the MPN (for intra-frequency handover, for example based on a list or database). The identification of the UE as associated with the MPN and/or initiation of the detach may then be performed in response to the determination.

Detach of the UE may be initiated at one or more of: a MME of the PLMN; a PGW of the MPN; and a HSS of the MPN.

Further general details of the disclosure will be considered below. First, additional specific embodiments are discussed.

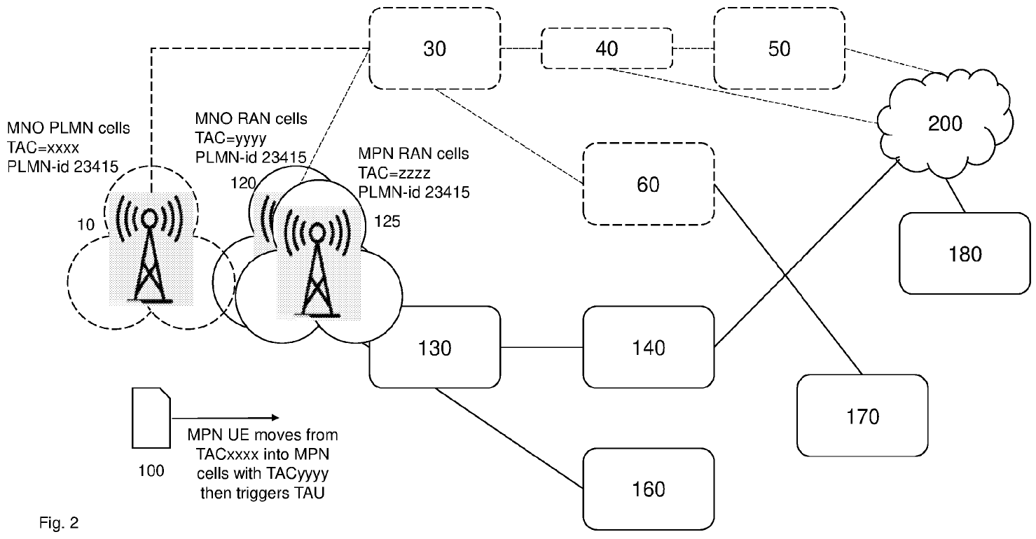

Referring next to FIG. 2, there is illustrated a schematic diagram of a network architecture where cells of a PLMN use a different frequency from cells of a MPN. Many of the features are the same as those shown in FIG. 1, so identical reference numerals are used for these. In this scenario, there are three tracking areas: a first Tracking Area 10; a second PLMN Tracking Area 120; and a second MPN Tracking Area 125. The second PLMN Tracking Area 120 and the second MPN Tracking Area 125 overlap, as shown.

As in the case of same-frequency deployment, discussed above, the first Tracking Area 10 has only PLMN cells and a first Tracking Area Code (TAC), xxxx. The second PLMN Tracking Area 120 also has only PLMN cells and a second TAC, yyyy. The second MPN Tracking Area 125 has only MPN cells and a third TAC, zzzz. The second TAC may identify that the second PLMN Tracking Area 120 overlaps with the second MPN Tracking Area 125. Again, the PLMN-id (PLMN identifier) for each of the PLMN and the MPN is the same (23415).

Where the MPN cells use a different frequency from the PLMN cells (but still the same PLMN-id), there are a number of possible approaches for initiating the UE detach. A first option may be similar to the TAU-triggered approach discussed above. When a MPN UE moves from the first Tracking Area 10 (TAC xxxx) into still dedicated PLMN cells in the second PLMN Tracking Area 120 (TAC yyyy), it then triggers a TAU. This may be based on the second TAC (yyyy) identifying that the second PLMN Tracking Area 120 overlaps with the second MPN Tracking Area 125. The same detach options and procedures as discussed above with reference to the case of the PLMN and MPN cells using the same frequency may apply. However, due to the use of different Tracking Areas for the PLMN and MPN cells, this approach may not be straightforward to implement. In particular, such a procedure may only be fully effective if the coverage area of the second PLMN Tracking Area 120 is almost identical to the coverage area of the second MPN Tracking Area 125, which can be difficult to design.

A second option is to use the inter-frequency handover procedure. Again, such a procedure begins when a MPN UE moves from the first Tracking Area 10 (TAC xxxx) into still dedicated PLMN cells in the second PLMN Tracking Area 120 (TAC yyyy) and MPN cells in the second MPN Tracking Area 125 (TAC zzzz). The MPN cells may start to appear on the UE inter-frequency measurement (event 4A). It may be possible (at the eNB or equivalent, for example) to adjust the inter-frequency handover threshold (event 4A threshold) so that the UE attempts (S1-based) inter-frequency handover (hard handover). This attempt will fail, because the PLMN MME 30 has no connection to the MPN MME 130. Although the handover attempt fails, the PLMN MME 30 and/or the MPN HSS 180 are notified of the attempt. Based on this notification, either of these network entities can trigger UE detach. This option also has a potential disadvantages, in that PLMN UE devices may also attempt hard handover to the MPN cells and fail. Whilst the PLMN UE devices will still remain attached to the PLMN, it may cause a flood of signalling, which may be detrimental. Even if the inter-frequency handover threshold is not adjusted, using the same PLMN-id between PLMN and MPN cells may still result in failed inter-frequency handover attempts, however.

A third option is to use an application on the UE to determine a location for the UE and to report location information, based on the determined location, to the network. The location can be determined by a Global Navigation Satellite System (GNSS). The application may report the location and/or may detect that the UE has entered into an MPN coverage area (geo-fencing area). The network may then perform the detach procedure based on the report. The application may also at least force the UE into idle mode. An extension of this option is using the Minimisation of Drive Test (MDT) feature described in 3GPP TS 37.320. In this feature, the GNSS location is included in a UE measurement report. The eNB can used this info to inform the PLMN MME 30, which may allow the PLMN MME 30 to perform a network detach. This would not require any change to UE operation (such as a dedicated application), but may need changes to the eNB operation.

Further details according to the general sense discussed above are now considered. In some embodiments, a cell of the PLMN to which the UE is attached uses a different frequency as a cell of the MPN.

Optionally, the PLMN may further determine that at least one cell of the MPN appears on a UE inter-frequency measurement. Then, the step of initiating a detach of the UE may comprise adjusting an inter-frequency handover threshold for the UE (for example, at a cell, base station or eNB). In embodiments, initiating a detach of the UE may include detecting at a MME of the PLMN, an inter-frequency handover attempt of the UE, the MME initiating the detach of the UE in response to the detection.

In some embodiments, a location report from the UE may be received at the PLMN. The location report may indicate that the UE is in a coverage area of the MPN (for example, by reporting the location and/or an indication of that the UE is in the coverage area of the MPN). Then, the identification of the UE as associated with the MPN and/or initiation of the detach may be performed in response to receiving the location report. As part of this process, the UE may determine its location and/or communicate a location report from the UE to the PLMN based on the determined location. Advantageously, the location report may be configured to instruct the PLMN to initiate the detach of the UE.

In a further generalised aspect, there may be considered a method for reporting location information for a User Equipment (UE) associated with a Mobile Private Network (MPN), the UE being configured to roam on a Public Land Mobile Network (PLMN), the method comprising: determining, at the UE, a location for the UE; and reporting location information, based on the determined location, to the PLMN. The location may be determined using a Global Navigation Satellite System (GNSS). The location information may comprise one or more of: the determined location; an indication that the UE has entered into coverage area of the MPN. A UE configured to operate in accordance with the method of this aspect may be provided, in an embodiment.

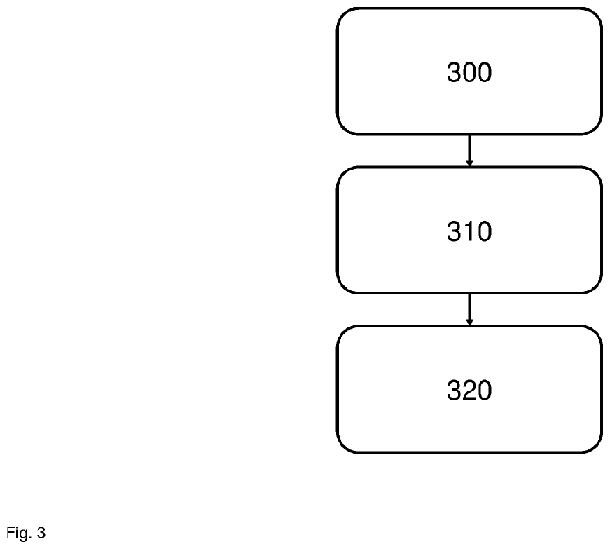

Referring now to FIG. 3, there is depicted a flow chart of a procedure according to the disclosure. In an identification step 300, the PLMN (particularly the core network of the PLMN) identifies that a UE that is roaming on the PLMN is associated with a MPN having overlapping coverage with the PLMN. As part of identification step 300, the PLMN may establish that the UE is located in an area of such overlapping coverage. In response to the identification step 300, a detach initiation step 310 takes place. The core network of the PLMN or the MPN initiates a detach of the UE from the PLMN in this step. In a detach and reattachment step 320, triggered by the detach initiation step 310, the UE is detached from the PLMN and reattaches to the MPN. This step may take place at the RAN of the PLMN. Other features may be included in this flow chart, as discussed above with reference to the specific embodiments.

Although specific embodiments have now been described, the skilled person will understand that various modifications and variations are possible. For example, whilst the disclosure is described in relation to existing network architecture, it will be understood that changes to the architecture (and/or nomenclature) are possible, but the present disclosure may still be applicable in this case. Also, combinations of any specific features shown with reference to one embodiment or with reference to multiple embodiments are also provided, even if that combination has not been explicitly detailed herein.

1. A method of instigating a reattachment of a User Equipment (UE) from a Public Land Mobile Network (PLMN), on which the UE is roaming, to a Mobile Private Network (MPN), the method comprising:
identifying at the PLMN that the UE is associated with the MPN; and
initiating, at a core network of the PLMN or the MPN, a detach of the UE from the PLMN in response to the identification.

2. The method of claim 1, wherein the step of identifying further comprises identifying at the PLMN that the UE is within Radio Access Network (RAN) coverage of the MPN.

3. The method of claim 1, wherein the UE is attached to a cell of the PLMN, the cell of the PLMN and a cell of the MPN having overlapping coverage areas, the same PLMN identifier and different Tracking Area Codes (TAC).

4. The method of claim 1, wherein the UE is attached to a cell of the PLMN, the cell of the PLMN using the same frequency as a cell of the MPN.

5. The method of claim 1, further comprising:
determining, at the core network of the PLMN, that the UE has triggered a Tracking Area Update (TAU) or an intra-frequency handover, the step of identifying being performed in response to the determination.

6. The method of claim 1, wherein the step of initiating a detach of the UE is performed by one or more of: a Mobility Management Entity (MME) of the PLMN; a central Packet Data Network Gateway (PGW) of the MPN; and a Home Subscriber Server (HSS) of the MPN.

7. The method of claim 1, further comprising:
determining, at the PLMN, that at least one cell of the MPN appears on a UE inter-frequency measurement; and
wherein the step of initiating a detach of the UE comprises adjusting an inter-frequency handover threshold for the UE.

8. The method of claim 7, wherein the step of initiating a detach of the UE further comprises detecting at a Mobility Management Entity (MME) of the PLMN, an inter-frequency handover attempt of the UE, the MME initiating the detach of the UE in response to the detection.

9. The method of claim 1, further comprising:
receiving a location report from the UE at the PLMN, the location report indicating that the UE is in a coverage area of the MPN, the step of identifying being performed in response to receiving the location report.

10. The method of claim 9, further comprising:
determining at the UE, a location of the UE; and
communicating a location report from the UE to the PLMN based on the determined location, the location report being configured to instruct the PLMN to initiate the detach of the UE.

11. A network entity of a Public Land Mobile Network (PLMN), the PLMN being configured to allow a User Equipment associated with a Mobile Private Network (MPN) to roam on the PLMN, the network entity comprising:
one or more processors;
a non-transitory computer storage medium having stored thereon computer executable instructions that, when executed by the one or more processors, cause the network entity to perform the following:
identifying at the PLMN that the UE is associated with the MPN; and
initiating, at a core network of the PLMN or the MPN, a detach of the UE from the PLMN in response to the identification.

12. The network entity of claim 11, wherein the step of identifying further comprises identifying at the PLMN that the UE is within Radio Access Network (RAN) coverage of the MPN.

13. The network entity of claim 11, wherein the UE is attached to a cell of the PLMN, the cell of the PLMN and a cell of the MPN having overlapping coverage areas, the same PLMN identifier and different Tracking Area Codes (TAC).

14. The network entity of claim 11, wherein the UE is attached to a cell of the PLMN, the cell of the PLMN using the same frequency as a cell of the MPN.

15. The network entity of claim 11, the network entity further caused to perform:
determining, at the core network of the PLMN, that the UE has triggered a Tracking Area Update (TAU) or an intra-frequency handover, the step of identifying being performed in response to the determination.

16. The network entity of claim 11, wherein the step of initiating a detach of the UE is performed by one or more of: a Mobility Management Entity (MME) of the PLMN; a central Packet Data Network Gateway (PGW) of the MPN; and a Home Subscriber Server (HSS) of the MPN.

17. The network entity of claim 11, the network entity further caused to perform:
determining, at the PLMN, that at least one cell of the MPN appears on a UE inter-frequency measurement; and
wherein the step of initiating a detach of the UE comprises adjusting an inter-frequency handover threshold for the UE.

18. The network entity of claim 11, wherein the step of initiating a detach of the UE further comprises detecting at a Mobility Management Entity (MME) of the PLMN, an inter-frequency handover attempt of the UE, the MME initiating the detach of the UE in response to the detection.

19. The network entity of claim 11, the network entity further caused to perform:
receiving a location report from the UE at the PLMN, the location report indicating that the UE is in a coverage area of the MPN, the step of identifying being performed in response to receiving the location report.

20. A non-transitory computer storage medium having stored thereon computer executable instructions that, when executed by one or more processors, cause a network entity of a Public Land Mobile Network (PLMN), the PLMN being configured to allow a User Equipment associated with a Mobile Private Network (MPN) to roam on the PLMN, to perform the following:
identifying at the PLMN that the UE is associated with the MPN; and
initiating, at a core network of the PLMN or the MPN, a detach of the UE from the PLMN in response to the identification.
